(19) United States
(12) Patent Application Publication
(10) Pub. No.: US 2015/0285458 A1
(43) Pub. Date: Oct. 8, 2015

(54) VEHICLE HEADLAMP SYSTEM

(71) Applicant: Ford Global Technologies, LLC, Dearborn, MI (US)

(72) Inventors: Mahendra Somasara Dassanayake, Bloomfield Hills, MI (US); Arun Kumar, Farmington Hills, MI (US); Michael Koherr, Euskirchen NRW (DE); Donald Paul Bilger, Livonia, MI (US); Doemoetoer Gulyas, Koln NRW (DE)

(73) Assignee: Ford Global Technologies, LLC, Dearborn, MI (US)

(21) Appl. No.: 14/247,480

(22) Filed: Apr. 8, 2014

(51) Int. Cl. F21S 8/10

(52) U.S. Cl. CPC F21S 48/1757; F21S 48/115; F21S 48/31

(57) ABSTRACT

A vehicle headlamp system includes a headlamp component with a reflecting element and a light source. The reflecting element includes an array of selectively controllable portions, and the light source provides a first output to the reflecting element. The system further includes a computer coupled to the light source and the reflecting element. The computer selectively operating the portions of the reflecting element to shape the first output into illumination areas according to at least one vehicle user characteristic.

### BACKGROUND

Vehicles such as automobiles are typically configured with headlamps for illuminating the area in front thereof. There are numerous beam profiles, corresponding to the environmental conditions in which the vehicle is operating, typically demanded from a vehicle's headlamps, such as high beams, low beams, turning beams, fog beams, daytime running beams, and others. In addition, there are different beam standards in different markets. Furthermore, while, in a given driving condition, the requirements and/or preferences for the operation of headlamps may vary from driver to driver. Accordingly, it is desirable, but currently difficult, to provide headlamp beam profiles variable on a per driver basis that operate within desired energy efficiency and packaging goals.

### DRAWINGS

FIG. 1 is a block diagram of an exemplary vehicle system.

FIG. 2 is a schematic illustration of an exemplary vehicle headlamp.

FIGS. 3-4 are schematic illustrations of the vehicle headlamp of FIG. 2 providing exemplary illumination areas.

FIG. 5 illustrates an exemplary process for operation of a headlamp.

### DETAILED DESCRIPTION

### System Overview

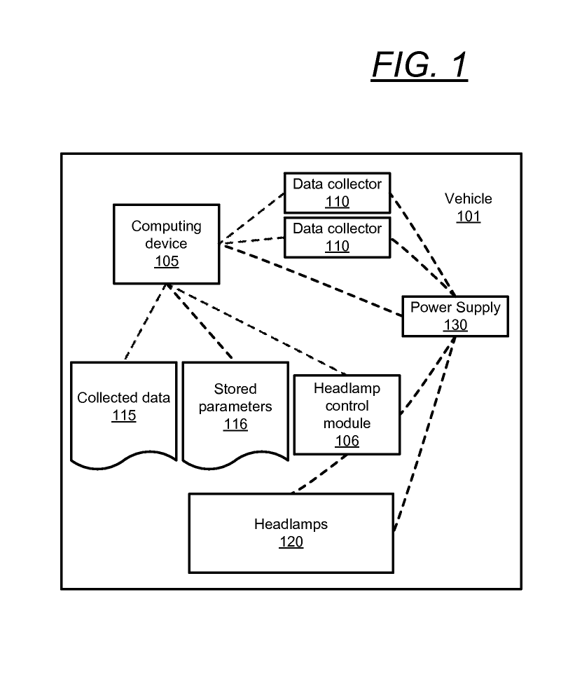

FIG. 1 is a block diagram of an exemplary autonomous vehicle system 100. A vehicle 101 includes the vehicle computer 105 that is configured to receive information, e.g., collected data 115, from one or more data collectors 110 related to various components or conditions of the vehicle 101, e.g., components such as a braking system, a steering system, a powertrain, etc., and/or conditions such as vehicle 101 speed, acceleration, pitch, yaw, roll, etc. The computer 105 generally includes a headlamp control module 106 that comprises instructions for operating headlamps 120 of the vehicle 101. Further, the computer 105, e.g., in the module 106, generally includes instructions for receiving data, e.g., from one or more data collectors 110 and/or a human machine interface (HMI), such as an interactive voice response (IVR) system, a graphical user interface (GUI) including a touchscreen or the like, etc.

The computer 105 may instruct the headlamp control module 106 according to one or more stored parameters 116. By evaluating collected data 115 with respect to one or more stored parameters 116 being used during autonomous driving operations, the computing device 105 can determine whether to adjust one or more of the parameters 116. For example, the module 106 may change a parameter 116 to correspond with one of a plurality of beam profiles for one or more headlamps 120 according to an acceleration or deceleration of vehicle 101, a detected object, an oncoming vehicle, road condition, environmental condition or the like, e.g., darkness, precipitation, etc. that may be detected or inferred by a data collector 110.

### Exemplary System Elements

A vehicle 101 includes a vehicle computer 105 that generally includes a processor and a memory, the memory including one or more forms of computer-readable media, and storing instructions executable by the processor for performing various operations, including as disclosed herein. Further, the computer 105 may include more than one computing device, e.g., controllers or the like included in the vehicle 101 for monitoring and/or controlling various vehicle components, e.g., an engine control unit (ECU), transmission control unit (TCU), etc. The computer 105 is generally configured for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including data collectors 110. Alternatively or additionally, in cases where the computer 105 actually comprises multiple devices, the CAN bus or the like may be used for communications between devices represented as the computer 105 in this disclosure. In addition, the computer 105 may be configured for communicating with an external network, which may include various wired (e.g., cable and fiber) and/or wireless (e.g., cellular, wireless, satellite, microwave, and radio frequency) networking technologies, e.g., wired and/or wireless packet networks, wireless communication networks (e.g., using Bluetooth, IEEE 802.11, etc.), local area networks (LAN) and/or wide area networks (WAN), including the Internet, providing data communication services, etc.

Generally included in instructions stored in and executed by the computer 105 is the headlamp control module 106. Using data received in the computer 105, e.g., from data collectors 110, data included as stored parameters 116, the module 106 may be used to regulate operation of headlamps 120. Further, the module 106 may include instructions for evaluating information received in the computer 105 relating to vehicle 101 operator characteristics, e.g., from an HMI and/or data collectors 110.

Data collectors 110 may include a variety of devices. For example, various controllers in a vehicle may operate as data collectors 110 to provide data 115 via the CAN bus, e.g., data 115 relating to vehicle speed, acceleration, etc. Further, sensors or the like, global positioning system (GPS) equipment, etc., could be included in a vehicle and configured as data collectors 110 to provide data directly to the computer 105, e.g., via a wired or wireless connection. Sensor data collectors 110 could include communication devices to send and receive information from other vehicles, such as path intentions from vehicles surrounding vehicle 101. Sensor data collectors 110 could include mechanisms such as RADAR, LADAR, sonar, etc. sensors that could be deployed to measure a distance between the vehicle 101 and other vehicles or objects. Yet other sensor data collectors 110 could include cameras, breathalyzers, motion detectors, etc., i.e., data collectors 110 to provide data for evaluating a condition or state of a vehicle 101 operator. In addition, data collectors 110 may include sensors to detect a position, change in position, rate of change in position, etc., of vehicle 101 components such as a steering wheel, brake pedal, accelerator, gearshift lever, etc.

A memory of the computer 105 generally stores collected data 115. Collected data 115 may include a variety of data collected in a vehicle 101. Examples of collected data 115 are provided above, and moreover, data 115 is generally collected using one or more data collectors 110, and may additionally include data calculated therefrom in the computer 105, and/or at the server 125. In general, collected data 115 may include any data that may be gathered by a collection device 110 and/or computed from such data. Accordingly, collected data 115 could include a variety of data related to vehicle 101 operations and/or performance, data received from another vehicle, as well as data related to environmental conditions, road conditions, etc. relating to the vehicle 101. For example, collected data 115 could include data concerning a vehicle 101 speed, acceleration, pitch, yaw, roll, braking, presence or absence of precipitation, tire pressure, tire condition, etc.

Returning to FIG. 1, a memory of the computer 105 may further store parameters 116. A parameter 116 generally governs control of a component of the vehicle 101, such as the headlamps 120. With regard to headlamps 120, these parameters vary due to the various range of beam profiles available through operation of headlamps 120, corresponding to an environmental condition, road condition, vehicle 101 condition, or the like. For example, a parameter 116 may specify a beam profile to be operated by headlamps 120, either by default, or according to one or more user settings, environmental conditions, road conditions, vehicle 101 conditions, etc., e.g., an intensity or type of precipitation, time of day, level of ambient light, etc. to achieve a desired illumination performance. Stored parameters 116 may also include parameters for default operation of the headlamps 120, parameters corresponding to operation of the headlamps 120 in different countries, and/or parameters corresponding to the operation preferences and/or requirements of the headlamps 120 for different drivers of vehicle 101.

Parameters 116 may also include parameters corresponding to different users of vehicle 101, i.e., one or more vehicle user characteristics. For example, if one user of vehicle 101 is relatively taller than another user, the stored parameters 116 may include a relatively elevated baseline direction of illumination for the headlamps 120—e.g., “low beam” operation for the taller driver may be angled higher, with respect to the road, than “low beam” operation for a relatively shorter driver. In other example, for drivers with different quality of vision, the parameters 116 may include an increased preference toward “high beam” operation for a driver with relatively poorer vision. Such vehicle user characteristics of stored parameters 116 may be, e.g., set through a user-interface in or in communication with the vehicle 101, and/or determined through collected data 115 by computer 105.

The vehicle 101 also includes a power supply system 130, e.g., a battery or battery system, coupled to the computer 105, the headlamp control module 106, the data collectors 110 and the headlamps 120. The power supply system 130 may be further coupled to additional powered components, e.g., media devices, alarms, and locking mechanisms, as well as power regeneration components and systems, such as solar panels and regenerative braking systems.

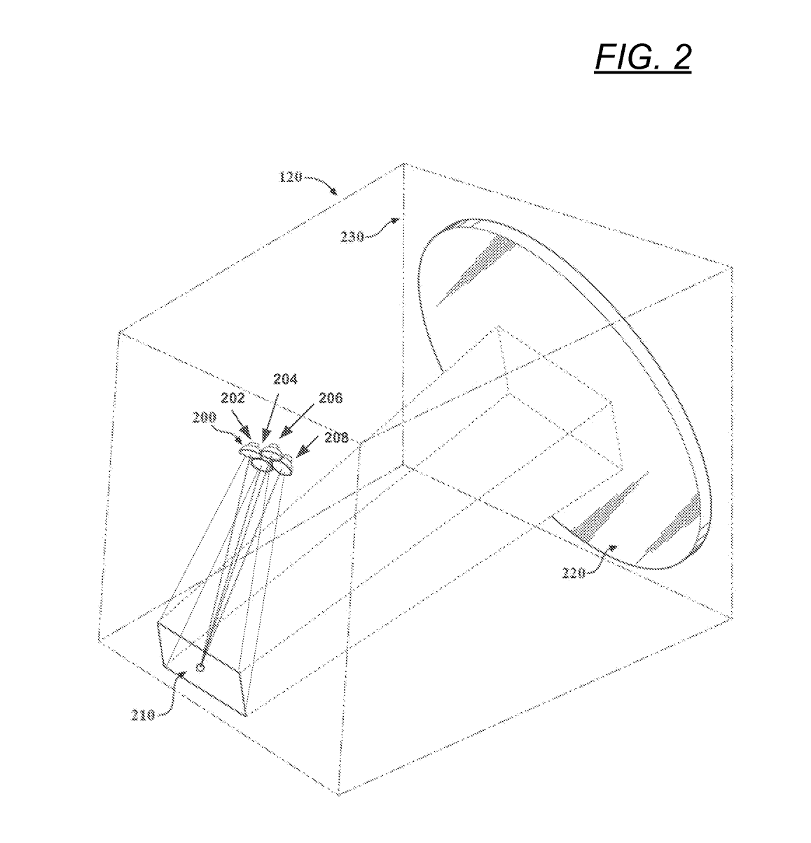

FIG. 2 illustrates an exemplary arrangement of components for a headlamp 120. The headlamp 120 includes a light source mechanism 200. The exemplary light source mechanism 200 includes four chip light emitting diodes (LED) 202, 204, 206, 208, such as, for example, manufactured by Osram or Nichia. The LEDs 202-208 are configured in a two by two array, and, in this example, are each a 1 mm by 1 mm chip-type of LED. The exemplary light source mechanism 200 may further include one or more components for directing the light at the reflecting element 210, such as a collimator component. It should be understood that the light source mechanism 200 may have a variety of configurations, e.g., variations in arrangement, number of components, size of components, and type of components, such as including a collimator component and/or a laser light source. The headlamp 120 further includes a selectively controllable reflecting array mechanism or element 210. For example, the reflecting element 210 may be a digital micromirror device (DMD) such as, for example, a Texas Instruments, Inc. DLP light processing chip, which is a digital micromirror device that selectively modulates an array of micromirrors, or pixels, at a very high rate of speed, or, in other examples, other selectively controlled multiple-reflecting portions or elements. The headlamp further includes a lens 220 and a support housing or box 230 surrounding the light source mechanism 200, the reflecting element 210, and the lens 220.

In one example, the dimensions of the support box 230 are 70 mm by 70 mm by 100 mm; the overall size of the light source mechanism 200 is 26 mm by 26 mm by 20 mm; the reflecting element 210 is a 1920 by 1080 mirror DMD chip with dimension of 20.75 mm by 11.67 mm; and the lens 220 has a diameter of 90-100 mm and a thickness of 18 mm. In such an example, the light source mechanism 210 is arranged 50 mm from the center of the face of the reflecting element 210, at an angle of proximately 24 degrees relative to the face of the reflecting element 210. In such an exemplary arrangement, operation of the headlamp 120 achieves a maximum intensity of at least 70,000 candela, while the light source mechanism 200 and the reflecting element 210 draw power of approximately 18 watts. In such an example, the configuration of the headlamp 120 provides a relatively highly energy efficient optical system with performance of sufficient magnitude to meet many typical applications for headlamps in vehicles.

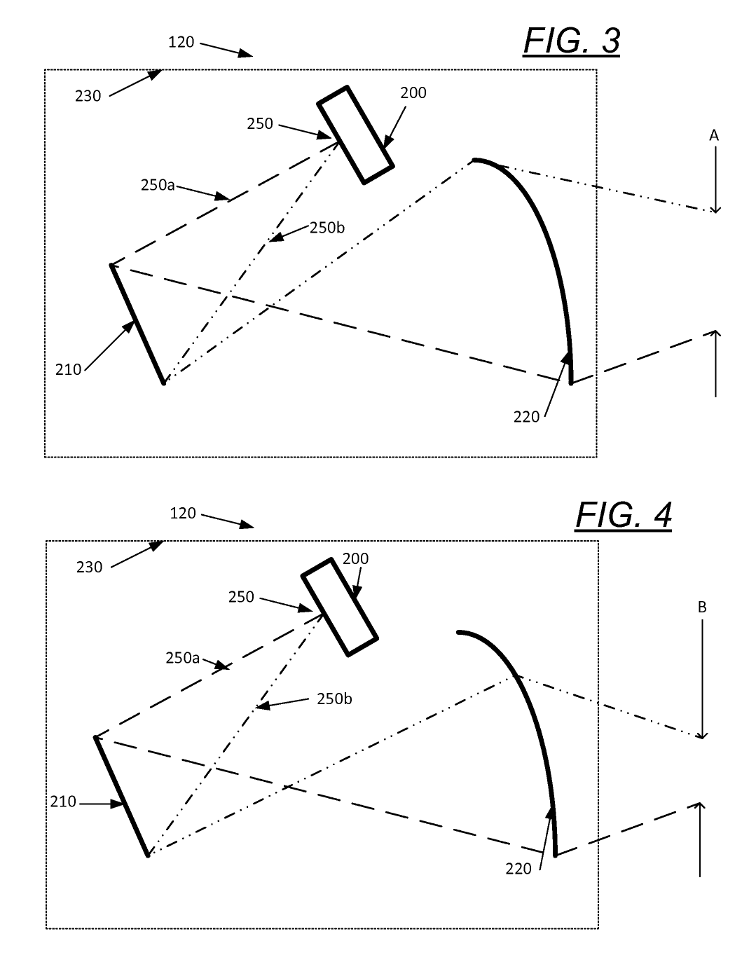

FIGS. 3-4 illustrate the headlamp 120 operating to provide varied illumination areas A and B with a first output 250. The housing 230 contains light source mechanism 200, reflecting element 210, and lens 220. The light source 200 emits a first output 250 having boundaries 250a and 250b. The arrangement between first output 250 and the reflecting element 210 is constant. The computer 105 and module 106 operate at least some of the portions of the reflecting array of reflecting element 210 to provide different illumination areas A and B. In one example, the illumination areas A and B correspond to “high beam” and “low beam” operation of the vehicle 101, by default or for a single user. In another example, illumination areas A and B correspond to “high beam” or “low beam” operation for two different users with different user characteristics among stored parameters 116. In another example, illumination areas A and B correspond to first and second beam profiles in response to collected data 115, such as detection by sensors 110 of an oncoming car, or detection by sensors 110 of a change in the ambient light around vehicle 101.

### Exemplary Process Flow

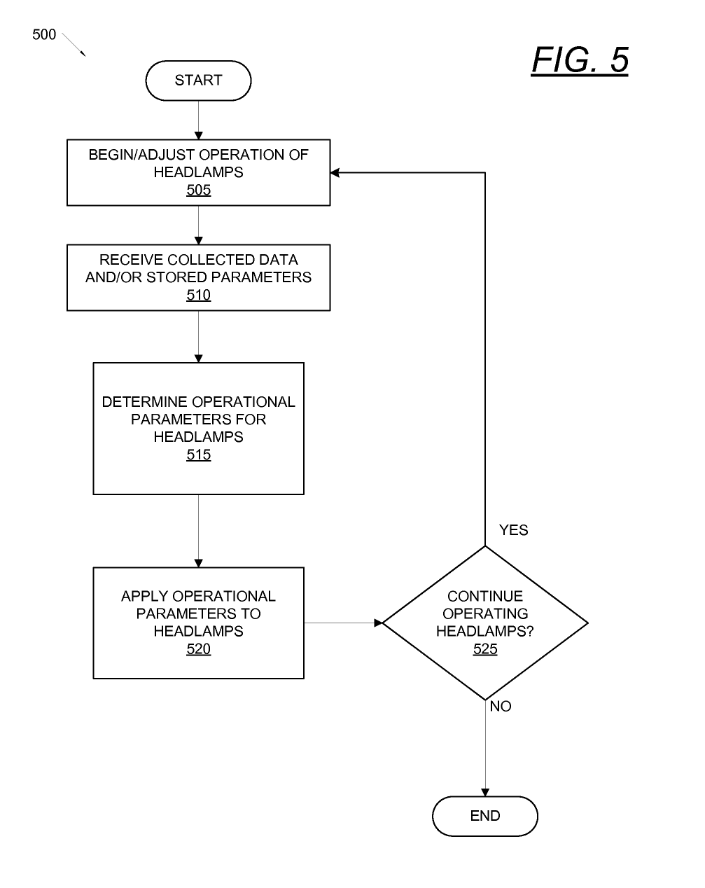

FIG. 5 is a diagram of an exemplary process 500 for operation of the headlamps 120 of vehicle 101 through computer 105 and headlamp control module 106. It should be understood that the process 500 may also be applied to a vehicle with a single headlamp.

The process 500 begins in a block 505, in which the vehicle 101 commences or continues operation of the vehicle headlamps 120, e.g., the vehicle user turns on the headlamps 120, or the computer 105 instructs the headlamp control module 106 to operate the headlamps according to collected data 115 and/or stored parameters 116, such as when darkness is detected by a data collection device 110.

Following the block 505, in a block 510, the computer 105 receives collected data 115 and stored parameters 116, which may include vehicle user characteristics, such as the height, age and specific preferences of the particular vehicle operator. As mentioned above, collected data 115 may be provided via one or more of a variety of data collection devices 110, and may include data concerning vehicle 101 speed, pitch, yaw, roll, environmental conditions, road conditions, communications from other vehicles, etc.

Following the block 510, in a block 515, the computer 105 selects operational parameters for the vehicle headlamps 120 from the stored parameters 116. For example, the computer 105 selects parameters 116 to operate the vehicle headlamps 120 in a mode appropriate for the conditions of vehicle 101, relative to the vehicle user characteristics and preferences stored as parameters 116. In such an example, if “low beam” mode is determined as appropriate, i.e., computer 105 determines through collected data 115 (from location data or communications from other vehicles) that the vehicle 101 is driving in congested conditions, the computer 105 further instructs the headlamp control module 106 to provide a “low beam” per the particularly applicable vehicle user characteristics. Accordingly, where possible, process 500 provides for at least partial personal optimization of the operation of vehicle headlamps 120. It should be understood that a pair of vehicle headlamps 120 may be operated according to different parameters in any mode of operation, e.g., the headlamp 120 that is positioned closer to oncoming traffic may have a different profile than the other headlamp, to avoid inhibiting the visibility of other vehicle drivers.

Following block 515, in a block 520, those selected operational parameters for the vehicle headlamps 120 are applied by module 106 in the operation of the vehicle headlamps 120. After the application, of the operational parameters selected from the stored parameters 116, then the block 525 is executed next, to determine if vehicle 101 is to continue operation of the headlamps 120. If not, e.g., the destination is reached or the vehicle conditions have changed, the process 500 ends. If vehicle 101 is to continue operating the headlamps 120, process 500 returns to the blocks 505-520, to continue dynamic control of the headlamps 120.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a vehicle headlamp including a reflecting element and a light source, the reflecting element including an array of selectively controllable portions, the light source providing a first output to the reflecting element; and
a computer coupled to the light source and the reflecting element, the computer selectively operating the portions of the reflecting element to shape the first output into illumination areas according to at least one vehicle user characteristic.

2. The system of claim 1, wherein the light source of the vehicle headlamp includes an LED component.

3. The system of claim 2, wherein the light source of the vehicle headlamp is an assembly of four LED components.

4. The system of claim 3, wherein the light source of the vehicle headlamp includes a collimator component directing the first output to the reflecting element.

5. The system of claim 3, wherein the assembly of four LED components is in the configuration of a two by two array.

6. The system of claim 4, wherein the four LED components are each a 1 mm by 1 mm chip LED.

7. The system of claim 6, wherein the light source provides the vehicle headlamp with an output of at least 70,000 candela.

8. The system of claim 1, wherein the vehicle headlamp includes a lens and a housing containing the light source, the reflecting element, and the lens.

9. The system of claim 1, wherein the vehicle headlamp includes a lens and a housing, the housing supporting the light source, the reflecting element, and the lens therewith.

10. The system of claim 9, wherein the housing has a shape of a rectangular box.

11. The system of claim 10, wherein the housing has dimensions substantially equal to 70 mm by 70 mm by 100 mm.

12. The system of claim 10, wherein the reflecting element is a digital micromirror device and the light source is an assembly of four 1 mm by 1 mm chip LEDs configured in a two by two array.

13. The system of claim 12, wherein the reflecting element has dimensions substantially equal to 20.75 mm by 11.67 mm.

14. The system of claim 1, further comprising a power system coupled to the light source, the reflecting element, and the computer.

15. The system of claim 14, wherein the reflecting element is a digital micromirror device, the light source is an assembly of four 1 mm by 1 mm chip LEDs configured in a two by two array, and the light source draws substantially 18-watts of power from the power system to provide the vehicle headlamp an output of at least 70,000 candela.

16. The system of claim 1, wherein the at least one vehicle user characteristic is one of a height and a vision quality of a vehicle user.
